(19) United States
(12) Patent Application Publication
(10) Pub. No.: US 2018/0264632 A1
(43) Pub. Date: Sep. 20, 2018

(54) REVERSING RATCHET WRENCH

(71) Applicant: Chia-Yu CHEN, Taichung City (TW)

(72) Inventor: Chia-Yu CHEN, Taichung City (TW)

(21) Appl. No.: 15/458,823

(22) Filed: Mar. 14, 2017

(51) Int. Cl. B25B 13/46

(52) U.S. Cl. CPC B25B 13/463

(57) ABSTRACT

A reversing ratchet wrench includes a head, a ratchet wheel, a ratchet block, a change-over unit and a position-limiting member. The position-limiting member is transversely fixed at the underside of the change-over unit, and the change-over unit has its upper end provided with an actuating member, which can be turned to actuate the position-limiting member to rotate. When the position-limiting member is actuated by the actuating member to lie at a first position, the first stop end of the position-limiting member will be stopped at the inner wall of one side of a ring groove and, when the position-limiting member is actuated to lie at a second position, the second stop end will be stopped at the inner wall of another side of the ring groove. Thus, the actuating member can be restrictedly positioned via the position-limiting member.

### BACKGROUND OF THE INVENTION

### 1. Field of the Invention

This invention relates to a ratchet wrench, particularly to a reversing ratchet wrench.

### 2. Description of the Prior Art

A conventional ratchet wrench, as shown in FIGS. 1-3, includes a head 1 having its topside formed with a recessed groove 2 and its interior provided with a ratchet wheel 3, a ratchet block 4 and a change-over unit 5. The change-over unit 5 is disposed therein with a position-limiting groove 7 received therein with an elastic member 8 and a push member 9. The push member 9 is actuated by the elastic member 8 to have one side protruding out of the position-limiting groove 7 and pushing against one side of the ratchet block 4 to enable the ratchet wheel 3 and the ratchet block 4 to be engaged with each other. Further, the change-over unit 5 has a topside set with an actuating member 6 corresponding to the interior of the recessed groove 2 to enable the actuating member 6 to be turned around within the recessed groove 2 and stopped at the inner wall of two sides of the recessed groove 2, letting the actuating member 6 restrictedly positioned by the recessed groove 2.

However, the recessed groove 2 of the head 1 of the conventional ratchet wrench is formed by cutting processing, and the method of cutting processing makes the manufacturing process of the head 1 become complicated and need to take much time. Therefore, in view of the above-mentioned drawbacks, the inventor of this invention thinks that the conventional ratchet wrench is necessary to be ameliorated and hence devises this invention.

### SUMMARY OF THE INVENTION

The objective of this invention is to offer a reversing ratchet wrench able to improve drawbacks of the conventional ratchet wrench that manufacturing process of the head of the conventional ratchet wrench is complicated and wastes much time.

The reversing ratchet wrench in the present invention includes a shank and a head combined together. The head is oppositely formed with a topside and an underside and provided with an accommodating groove and a control slot at the underside. The accommodating groove is pivotally provided therein with a ratchet wheel, and a ratchet moving groove is disposed between the accommodating groove and the control slot and a ratchet block is slidably received in the ratchet moving groove. The head further has the underside formed with a ring groove. A change-over unit is pivotally mounted in the control slot, having an upper end provided with an actuating member opposite to the topside of the head and having one end resisting against the ratchet block. The change-over unit can be driven by turning of the actuating member to rotate and make the ratchet block shift transversely in the ratchet moving groove. Moreover, a bottom plate is fixed with the ring groove of the head. The reversing ratchet wrench further contains a position-limiting member transversely secured at the underside of the change-over unit and positioned in the ring groove. Two ends of the position-limiting member are respectively a first stop end and a second stop end, and the position-limiting member is formed with a first position and a second position. When the position-limiting member is driven by the actuating member to lie at the first position, the first stop end will be stopped at the inner wall of one side of the ring groove, and when the position-limiting member is reversely driven to lie at the second position, the second stop end will be stopped at the inner wall of another side of the ring groove. Thus, the actuating member can be restrictedly positioned via the position-limiting member.

Specifically, the reversing ratchet wrench of this invention is to have the actuating member turned to actuate the position-limiting member to rotate to the first position to have the first stop end stopped at the inner wall of one side of the ring groove, and have the actuating member reversely driving the position-limiting member to rotate to the second position to have the second stop end stopped at the inner wall of another side of the ring groove, letting the actuating member restrictedly positioned via the position-limiting member. Thus, this invention is able to ameliorate drawbacks of the conventional ratchet wrench that manufacturing process of the recessed groove of the head is complicated and needs to take much time.

### BRIEF DESCRIPTION OF DRAWINGS

This invention will be better understood by referring to the accompanying drawings, wherein:

FIG. 1 is a perspective view of a conventional ratchet wrench;

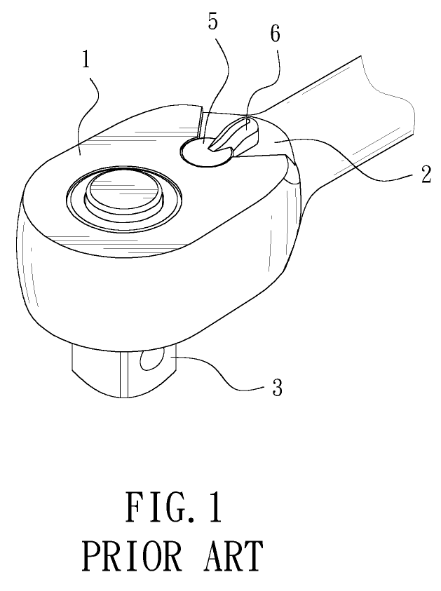

FIG. 2 is an exploded perspective view of the conventional ratchet wrench;

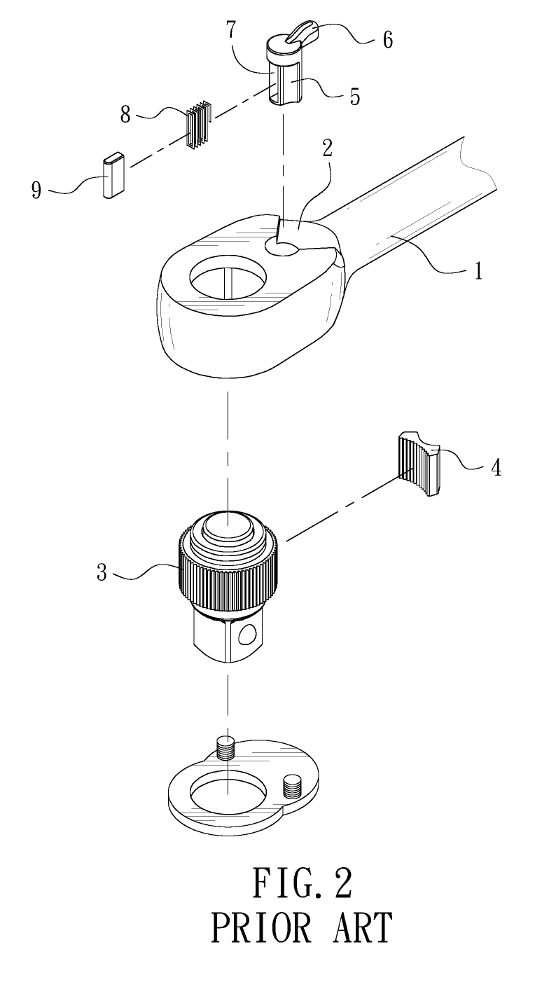

FIG. 3 is a cross-sectional view of the conventional ratchet wrench;

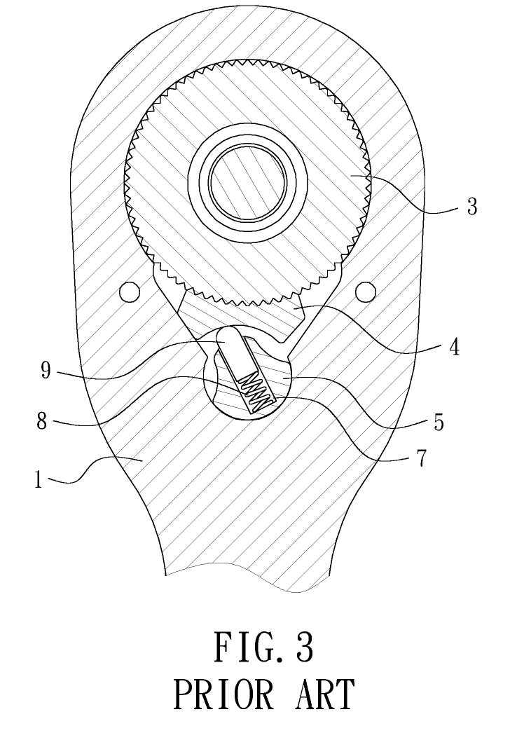

FIG. 4 is a perspective view of a reversing ratchet wrench in the present invention;

FIG. 5 is an exploded perspective view of the reversing ratchet wrench in the present invention;

FIG. 6 is a side partial cross-sectional view of the reversing ratchet wrench in the present invention;

FIG. 7 is a schematic view of the internal structure of the reversing ratchet wrench after a bottom plate is detached in the present invention;

FIG. 8 is a schematic view showing that an actuating member is turned to a first position in the present invention;

FIG. 9 is a schematic view showing that a position-limiting member is rotated to a first position in the present invention;

FIG. 10 is a schematic view showing that the actuating member is turned to a second position in the present invention; and

FIG. 11 is a schematic view showing that the position-limiting member is rotated to a second position in the present invention.

### DETAILED DESCRIPTION OF THE PREFERRED EMBODIMENT

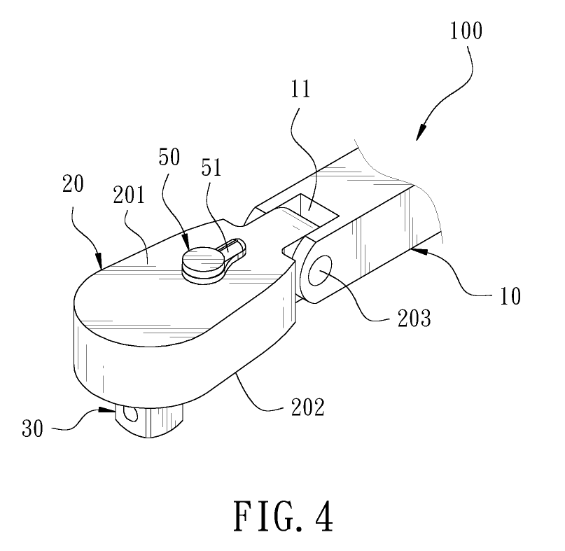

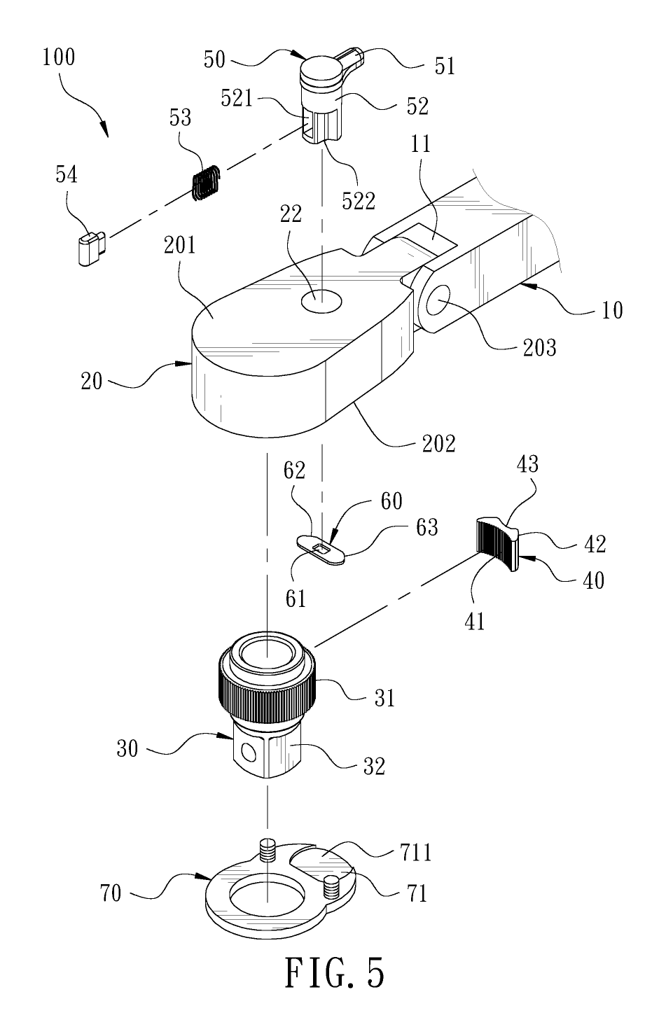

A preferred embodiment of a reversing ratchet wrench in the present invention, as shown in FIGS. 4-7, includes a shank 10, a head 20, a ratchet wheel 30, a ratchet block 40, a change-over unit 50, a position-limiting member 60 and a bottom plate 70 as main components combined together.

The shank 10 has one end longitudinally provided with a recessed groove 11 corresponding to a central axis.

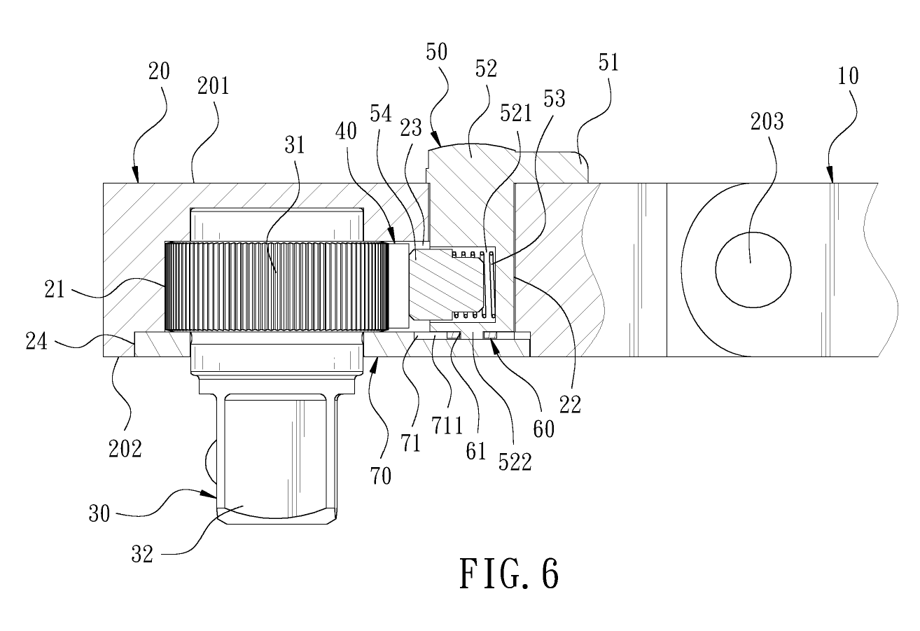

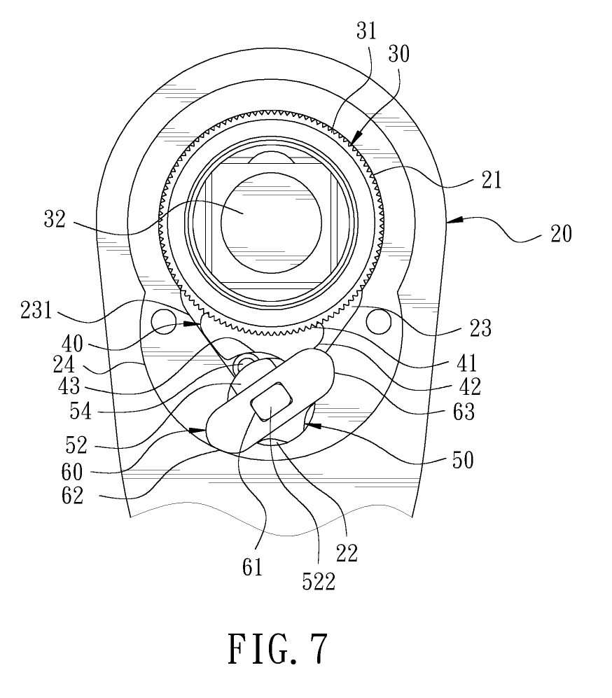

The head 20 has one end fixed with the recessed groove 11 of the shank 10, and the shank 10 and the head 11 are pivotally connected with each other by a pivot 203. Referring to FIGS. 6 and 7, the head 20 is formed with a topside 201 and an underside 202 corresponding to each other. The underside 202 of the head 20 is provided with a round accommodating groove 21 whose central axis is perpendicular to the underside 202 and disposed with a control slot 22 at a location near the shank 10. The control slot 22 is round-shaped and passes through the topside 201, and the central axis of the control slot 22 and the central axis of the accommodating groove 21 are parallel to each other. A ratchet moving groove 23 is disposed between the accommodating groove 21 and the control slot 22 and has two inner side walls respectively formed with a resisting section 231. The underside 202 of the head 20 is further provided with ring groove 24.

The ratchet wheel 30 is pivotally received in the accommodating groove 21 of the head 20, having its outer circumference annularly provided with a plurality of driving teeth 31 and its central axis provided with a braking member 32, which is selected to correspond to a sleeve for turning around a work piece.

The ratchet block 40 slideably installed in the ratchet moving groove 23 of the head 20 is formed with a plurality of ratchets 41 at one side facing the ratchet wheel 30, and the ratchets 41 of the ratchet block 40 can be engaged with the driving teeth 31 of the ratchet wheel 30. Moreover, the ratchet block 40 has two sides respectively formed with a resisted section 42 corresponding to the resisting sections 231, and the ratchet block 40 is formed with a pushed section 43 at one side facing the control slot 22, the pushed section 43 being concave arc-shaped.

The change-over unit 50 to be installed in the control slot 22 contains a control member 52 having its upper end provided with an actuating member 51 located at the topside 201 of the head 20. The control member 52 is disposed with a position-limiting groove 521 at a location facing the ratchet block 40, and the position-limiting groove 521 is provided therein with an elastic member 53 and a push member 54, the elastic member 53 being a spring. The push member 54 is pushed by the elastic member 53 and has one side protruding out of the position-limiting groove 521, and the protruding end of the push member 54 will push against one side of the pushed section 43 of the ratchet block 40 and simultaneously actuate the ratchet block 40 to push against one of the two resisting sections 231 of the ratchet moving groove 23 as well as the ratchet wheel 30. Further, the control member 52 has its underside provided with a rectangular projection 522.

The position-limiting member 60 is an oblong plate transversely mounted at the underside of the change-over unit 50 and located in the ring groove 24 and bored with a rectangular hole 61 at a location corresponding to the rectangular projection 522 at the underside of the control member 52, letting the rectangular projection 522 firmly inserted in the rectangular hole 61. Further, the position-limiting member 60 is formed with a first position and a second position, and two ends of the position-limiting member 60 are respectively a first stop end 62 and a second stop end 63. Thus, when the position-limiting member 60 is driven by the actuating member 51 and rotated to the first position, the first stop end 62 will be stopped at the inner wall of one side of the ring groove 24, and when the position-limiting member 60 is reversely driven by the actuating member 51 to lie at the second position, the second stop end 63 will be stopped at the inner wall of another side of the ring groove 24, letting the actuating member 51 positioned restrictedly.

The bottom plate 70 secured with the ring groove 24 of the head 20 is formed with a recessed groove 71 at a location corresponding to the position-limiting member 60 to form a rotation space 711 for enabling the position-limiting member 60 to rotate within the recessed groove 71.

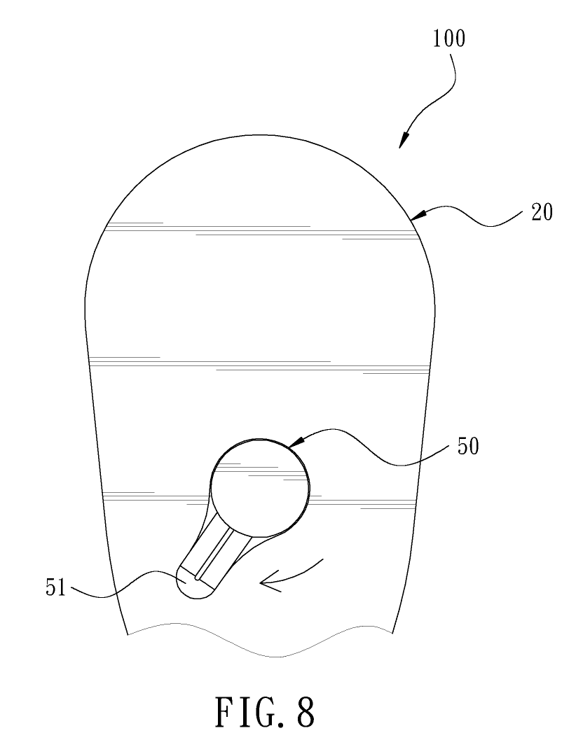

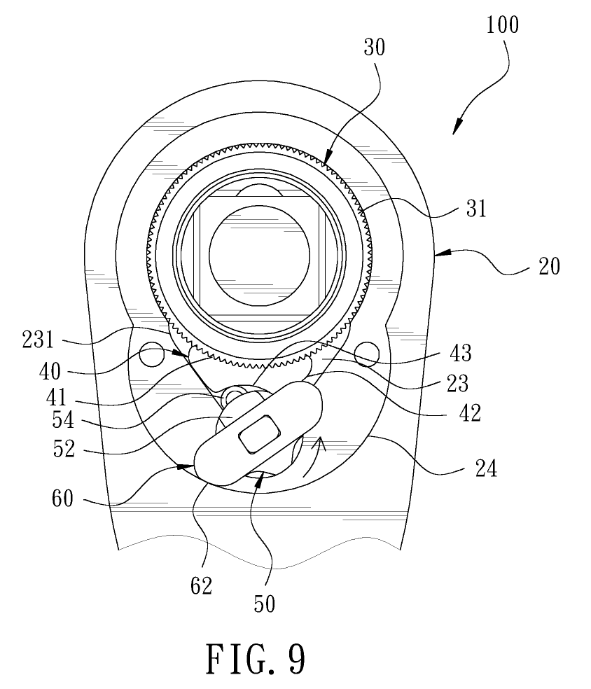

In use of the reversing ratchet wrench, referring to FIGS. 8 and 9, to carry out operation of tightening a work piece clockwise, the actuating member 51 is turned clockwise to drive the position-limiting member 60 to lie at the first position to have the first stop end 62 stopped at the inner wall of one side of the ring groove 24, rendering the actuating member 51 restrictedly positioned via the position-limiting member 60. Simultaneously, the push member 54 will be actuated to have one end pushing against one side of the pushed section 43 of the ratchet block 40, letting the resisted section 42 of the ratchet block 40 resist against the resisting section 231 of the ratchet moving groove 23 and making the ratchets 41 of the ratchet block 40 engaged with the driving teeth 31 of the ratchet wheel 30 so that the ratchet wheel 30 and the ratchet block 40 can produce restraint effect for enabling the ratchet wrench 100 to carry out clockwise turning and tightening operation.

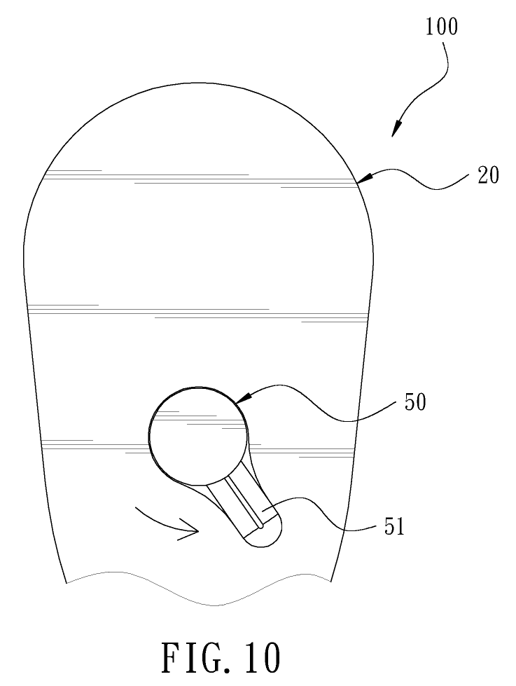

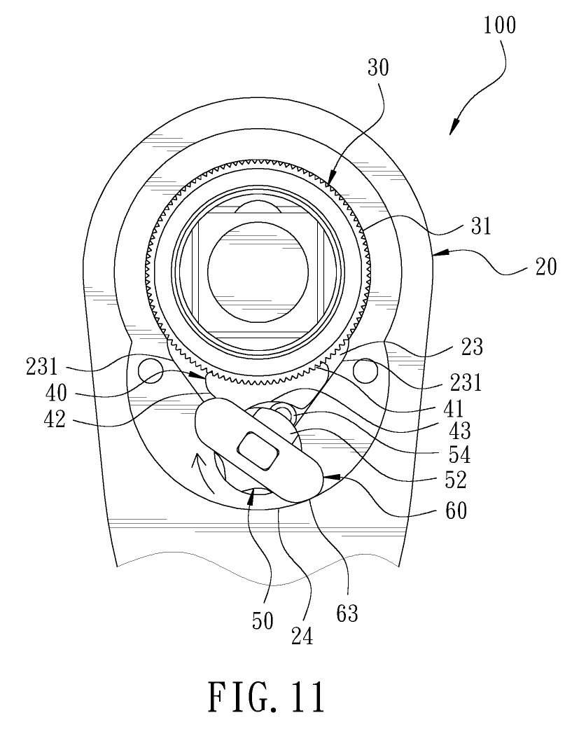

Referring to FIGS. 10 and 11, to carry out operation of tightening a work piece counterclockwise, the actuating member 51 is turned counterclockwise to drive the position-limiting member 60 to be at the second position to have the second stop end 63 stopped at the inner wall of another side of the ring groove 24 and thus; the actuating member 51 can be restrictedly positioned via the position-limiting member 60. Meanwhile, the push member 54 will be actuated to have one end pushing against another side of the pushed section 43 of the ratchet block 40, letting the resisted section 42 of the ratchet block 40 resist against the resisting section 231 of the ratchet moving groove 23 and making the ratchets 41 of the ratchet block 40 and the driving teeth 31 of the ratchet wheel 30 engaged together to form restraint effect for enabling the ratchet wrench 100 to carry out turning operation counterclockwise.

What is worth mentioning is that the reversing ratchet of this invention is to have the actuating member turned clockwise to drive the position-limiting member 60 to lie at the first position to enable the first stopping end 62 to be stopped at the inner wall of one side of the ring groove 24, and have the actuating member 51 turned counterclockwise to drive the position-limiting member 60 to be at the second position to enable the second stopping end 63 to be stopped at the inner wall of another side of the ring groove 24. Thus, the actuating member 51 can be restrictedly positioned by turning of the actuating member 51 to actuate the position-limiting member 60 to be stopped at the inner wall of the ring groove 24. In addition, since the topside 201 of the head 20 of the reversing ratchet wrench in the present invention is a plane surface; therefore, the head 20 can be molded in a way of power metallurgy, simple and time-saving in manufacturing process and further, the position-limiting member 60 is compression molded so it can be produced in great amount. Apparently, the reserving ratchet wrench of this invention has advantages over the conventional ratchet wrench that is complicated and the time-consuming in manufacturing the head of the ratchet wrench.

While the preferred embodiment of the invention has been described above, it will be recognized and understood that various modifications may be made therein and the appended claims are intended to cover all such modifications that may fall within the spirit and scope of the invention.

What is claimed is:

1. A reversing ratchet wrench comprising a shank and a head, said head formed with a topside and an underside opposite to each other, said underside of said head provided with an accommodating groove and a control slot, said accommodating groove pivotally mounted therein with a ratchet wheel, a ratchet moving groove disposed between said accommodating groove and said control slot, a ratchet block slidably installed in said ratchet moving groove, said underside of said head formed with a ring groove, a change-over unit pivotally received in said control slot, said change-over unit having an upper end set with an actuating member opposite to said topside of said head, said change-over unit having one end resisting against said ratchet block, said change-over unit actuated to rotate and make said ratchet block shift transversely in said ratchet moving groove via turning of said actuating member, a bottom plate fixed with said ring groove of said head; and characterized by,
a position-limiting member transversely provided at an underside of said change-over unit, said position-limiting member located in said ring groove, two ends of said position-limiting member respectively being a first stop end and a second stop end, said position-limiting member formed with a first position and a second position, said first stop end stopped at an inner wall of one side of said ring groove when said position-limiting member is actuated by said actuating member to lie at the first position, said second stop end stopped at an inner wall of another side of said ring groove when said position-limiting member is reversely actuated by said actuating member to lie at the second position;
Thus, said actuating member able to be restrictedly positioned via said position-limiting member.

2. The reversing ratchet wrench as claimed in claim 1, wherein said position-limiting member is an oblong plate.

3. The reversing ratchet wrench as claimed in claim 1, wherein said first stop end and said second stop end are respectively a cambered surface.

4. The reversing ratchet wrench as claimed in claim 1, wherein said bottom plate is provided with a recessed groove at a location corresponding to said position-limiting member, said recessed groove formed into a rotation space, said position-limiting member able to rotate within said recessed groove.

5. The reversing ratchet wrench as claimed in claim 1, wherein said change-over unit has a lower end provided with a rectangular projection and said position-limiting member is bored with a rectangular hole at a location corresponding to said rectangular projection, said rectangular projection inserted in said rectangular hole.

6. The reversing ratchet wrench as claimed in claim 1, wherein said change-over unit further comprises a control member, said control member provided with a position-limiting groove facing said ratchet moving groove, said position-limiting groove received therein with an elastic member and a push member, said elastic member being a spring, said push member pushed by said elastic member to have one side protruding out of said position-limiting groove and pushing against said ratchet block.
